(19) United States
(12) Patent Application Publication
(10) Pub. No.: US 2006/0248656 A1
(43) Pub. Date: Nov. 9, 2006

(54) New process of making permanent acid stain resistance for a lightly dyed polyamide carpet

(75) Inventor: Wae-Hai Tung, Marietta, GA (US)

Correspondence Address: INVISTA NORTH AMERICA S.A.R.L., THREE LITTLE FALLS CENTRE/1052, 2801 CENTERVILLE ROAD, WILMINGTON, DE, 19808, US

(73) Assignee: INVISTA NORTH AMERICA S.A.R.L., WILMINGTON, DE (US)

(21) Appl. No.: 11/123,282

(22) Filed: May 6, 2005

(51) Int. Cl. C11D 3/00

(52) U.S. Cl. 8/115.51

(57) ABSTRACT

The invention provides a process for making permanent stain resistant polyamide carpets with light color. The process comprises dyeing a low amine end and cationic dyeable polyamide carpet with acid dyes, and imparting stain resist compositions onto the carpet. In addition to stain resist compositions, a fluoro-chemical is also applied to improve soil resistance. The resulted carpet displays a built-in permanent anti-stain and anti-soil resistance after many shampoo-washes.

### FIELD OF THE INVENTION

This invention relates to a new process of making a lightly dyed polyamide carpet with permanent acid stain resistance. The carpet is made from cationic dyeable polyamide fibers with low amine ends, dyed with acid dyes, and treated with stain resistant compositions and/or fluoro-chemicals at a low pH. The lightly dyed polyamide carpet displays built-in permanent anti-stain and/or anti-soil resistance.

### BACKGROUND OF THE INVENTION

The information provided below is not admitted to be prior art to the present invention, but is provided solely to assist the understanding of the reader.

Cationic dyeable polyamide fibers are referred as basic dyeable polyamide fibers that commonly contain SO₃H or COOH groups within their polymer structure in an amount sufficient to render the polyamide fibers dyeable with a basic dye. More specially, the polyamide compositions comprise modified homopolyamides and copolyamides which are prepared by salt-blending a base polyamide precursor salt with a cationic dye modifier. Generally, the cationic dyeable polyamide fibers can absorb selectively cationic dyes in the dye bath of a mixture of acid dye and cationic dye, thus generating a color pattern in the carpet. It is very useful for styling in carpet industry. In addition, cationic dyeable polyamide fibers offer good stain resistant properties, particularly for acid dye type stains. To enhance the stain resistant properties, cationic dyeable polyamide fibers are dyed by acid dyes under certain conditions.

For example, as described in U.S. Pat. No. 5,468,554 to Windley, the specification of which hereby incorporated by reference in a manner consistent with this disclosure, at least 0.0048% of acid dyes was used in dyeing cationic dyeable polyamides articles. The amine ends are in the range of 20 to 40 per 10⁶ gram of copolyamide. The cationic dyeable polyamide fiber is heat set in Suessen (hot air at 185-215° C.). Generally, Superba heat set (saturated steam) opens up structure of the fiber and causes the fibers to be less stain resistant than corresponding fibers which are heat set by Suessen. Currently, the majority of BCF yarns are heat set on Superba. Suessen processes are mainly used for staple yarns. Suessen process is not suitable for BCF yarns due to its unacceptable process yields. The stain resistant property of carpet using the process disclosed by Windley cannot be sustained after the carpet is shampoo-washed, especially for a lightly dyed carpet.

U.S. Pat. No. 5,436,049 to Hu, the disclosure of which is hereby incorporated by reference in a manner consistent with this disclosure, discloses the carpet with low amine ends is treated by stain resistant compositions. The polyamides of low amine ends are obtained by adding chemical compounds that react with amino groups of polyamides. The stain resistant property disappears after shampoo-wash for a lightly dyed carpet.

One objective of the invention therefore is to provide a lightly dyed carpet, which can resist acid stain after many times of shampoo-wash.

Another objective of the invention is to develop a new process whereby a substantially uniformed lightly dyed carpet can be treated by stain resistant compositions at a low pH.

### SUMMARY OF THE INVENTION

The invention provides a process for making permanent stain resistant polyamide carpets with light color. The process comprises dyeing a low amine end and cationic dyeable polyamide carpet with acid dyes, and imparting stain resist compositions onto the carpet. In addition to stain resist compositions, a fluoro-chemical is also applied to improve soil resistance. The resulted carpet displays a built-in permanent anti-stain and/or anti-soil resistance after many shampoo-washes.

### DETAILED DESCRIPTION OF THE INVENTION

The process comprises melting a cationic dyeable polyamide copolymer with low amine ends, spinning the polymer melt into a yarn, heating set the yarn on Superba with steam, tufting the heat-set yarn into a carpet, spraying acid dyes on the carpet, steaming and rinsing the carpet, adding stain resist compositions on the carpet after rinsing, then steaming, rinsing, and drying the carpet. The pH of the dyeing is controlled in the range of about 3 to about 5. The pH of imparting stain resist compositions is controlled in the range of about 1.5 to about 5. A fluoro-chemical can be added with stain resist compositions to improve the soil resistance. Then the pH is controlled in the range of about 0.8 to about 2.5. Another embodiment of the present invention is a uniformly lightly colored carpet using cationic dyeable and low amine ends polyamide fibers. The carpet is prepared by the proceeding process. Such a carpet provides built-in permanent anti-stain resistance.

In another embodiment of the present invention, a process comprises melting a cationic dyeable polyamide copolymer with low amine ends, spinning the polymer melt into a yarn, heating set the yarn on Superba with steam, tufting the yarn into a carpet, spraying a mixture of acid dyes and stain resist compositions on the carpet, steaming, rinsing, and drying the carpet. The pH of spraying process is controlled in the range of about 1.5 to about 4.0 in the process. A fluoro-chemical is added with stain resist compositions in the above processes to improve soil resistance on the carpet. Then the pH of is controlled in the range of about 0.8 to about 2.5. A further embodiment of the present invention is a uniformly lightly colored carpet using cationic dyeable and low amine ends polyamide fibers. The carpet is prepared by the proceeding process. Such a carpet provides built-in permanent anti-stain resistance.

The amine ends in cationic dyeable polyamides are controlled about 12 to about 18 per million grams of polyamide fiber. The polyamide yarn is heat set on Superba with steam. The temperature is controlled in the range of about 110 to about 140° C.

Cationic dyeable polyamides are prepared by salt-blending a base polyamide precursor salt with a cationic dye modifier. Suitable cationic dye modifiers which may be used to produce the yarns of this invention include those aromatic sulfonates and their alkali metal salts which are capable of copolymerizing with polyamide-forming raw materials. Examples of such compounds include sulfonated dicarboxylic acids and the diesters of such diacids, with the most preferred modifier being the alkali metal salts of 5-sulfoisophthalic acids.

The cationic dyeable polyamide carpets are dyed with acid dyes. Examples for acid dyes include Nylanthrene by C & K (e.g. Black GLRT, Black GLWC, Blue B-AR 200%, Blue B-GA, Blue GLF, Orange B-GN, Orange 3G, Red 2RDF, Red 4RL, Yellow FLW, and Yellow SL 200%), Tectilon by Ciba-Geigy (e.g. Black GD, Blue 4GN, Blue GRL, Blue SGS, Blue 4R, Orange 3G, Orange 3R, Orange 4R, Red 2B, Red GR, Yellow 2G, and Yellow 4R), and Telon by Mobay (e.g. Blue ANL, Blue 4GL, Red 2BL 200, Red CD-R, Yellow FGL 200, Yellow K-RNL 200, and Yellow Brown 3GL). These examples are not to be viewed as limiting the scope of the invention as defined by the appended claims.

The carpet of the present invention is preferably dyeable in a light color having a lightness color L value of 60 or above, more preferably 70 or above, determined in accordance with CIE 1976.

The stain resistant compositions applied in the present invention are water-soluble or water-dispersible polymeric sulfonated phenol-formaldehyde condensation products, mixtures containing any of hydrolyzed maleic anhydride/α-olefin copolymers, hydrolyzed maleic anhydride/styrene copolymers, polymethacrylic acid polymers, polymethacrylic acid copolymers, or mixtures of the above compositions.

The polymeric sulfonated phenol-formaldehyde condensation products that are any of those described in the prior art as being useful as dye-resist agents or dye-fixing agents. Particular examples include diphenolic sulfones, and sulfonated naphthalene condensates. A particular sulfonated phenol-formaldehyde suitable used in the present invention contains a condensation product of 4,4′-dihydroxysulfone, formaldehyde and sulfonated naphthalene. Other sulfonated phenol-formaldehyde condensation products that may be used in the present invention include those disclosed in U.S. Pat. Nos. 5,501,591, 5,592,940, 4,680,212, 4,822,373, 4,937,123, 5,447,755, 5,654,068, 5,708,087, 5,707,708, 5,074,883, 4,940,757, 5,061,763, 5,629,376, which are all incorporated herein by reference in their entireties.

A variety of linear and branched chain alpha-olefins (a-olefin) can be used to form a copolymer with maleic anhydride. Particularly useful alpha-olefins are 1-alkenes, containing 4 to 12 carbon atoms, preferably C₄₋₁₀, such as isobutylene, 1-butene, 1-hexene, 1-octene, 1-decene, and dodecene.

A part of the maleic anhydride in the copolymer can be replaced by acrylic acid, methacrylic acid, itaconic acid, vinyl sulfonic acid, vinyl phosphonic acid, styrene sulfonic acid, alkyl(C₁₋₄) acrylate, alkyl(C₁₋₄) methacrylate, vinyl acetate, vinyl chloride, vinylidine chloride, vinyl sulfides, N-vinyl pyrrrolidone, acrylonitrile, acrylamide, and mixtures thereof. In another embodiment, a part of the maleic anhydride can be replaced by maleimide, N-alkyl (C₁₋₄) maleimides, N-phenylmaleimide, fumaric acid, crotonic acid, cinnamic acid, alkyl (C₁₋₁₈) esters of the foregoing acids, cycloalkyl (C₃₋₈) esters of the foregoing acids, sulfated castor oil, or the like.

The maleic anhydride copolymers useful in the present invention can be prepared according to the methods well-known in the art. The maleic anhydride polymers thus obtained can be hydrolyzed to the free acid or their salts by reaction with water or alkali, or they can also be reacted with C₁₋₄ alkyl alcohol to provide polymeric alpha-olefin/maleic acid monoesters. Generally, the hydrolyzed maleic anhydride polymer, or the monoester polymer, should be sufficiently water-soluble that a uniform application to a fibrous polyamide surface can be achieved at an appropriate acidity. However, applications using water dispersions of the polymer mixed with a suitable surfactant may be used to impart stain-resistance.

Preparation of maleic anhydride/alpha-olefin polymers is also described in Reissue U.S. Pat. No. 28,475 and in EP 306992 the disclosures of which are specifically incorporated by reference. These references contain further teaching of techniques for the preparation of such polymers.

The methacrylic polymer used in the present invention includes the polymethacrylic acid homopolymer as well as polymers formed from methacrylic acid and one or more other monomers. The monomers useful for copolymerization with the methacrylic acid are monomers having ethylenic unsaturation. Such monomers include, for example, monocarboxylic acids, polycarboxylic acids, and anhydrides; substituted and unsubstituted esters and amides of carboxylic acids and anhydrides; nitriles; vinyl monomers; vinylidene monomers; mono-olefinic and polyolefinic monomers; and heterocyclic monomers.

Representative specific monomers include, for example, acrylic acid, itaconic acid, citraconic acid, aconitic acid, maleic acid, maleic anhydride, fumaric acid, crotonic acid, cinnamic acid, oleic acid, palmitic acid, vinyl sulfonic acid, vinyl phosphonic acid, alkyl or cycloalkyl esters of the foregoing acids, alkyl or cycloalkyl having 1 to 18 carbon atoms such as, for example, ethyl, butyl, 2-ethylhexyl, octadecyl, 2-sulfoethyl, acetoxyethyl, cyanoethyl, hydroxyethyl and hydroxypropyl acrylates and methacrylates, and amides of the foregoing acids, such as, for example, acrylamide, methyacrylamide, amd 1,1-dimethylsulfoethylacrylamide, acrylonitrile, methacrylonitrile, styrene, α-methylstyrene, p-hydroxystyrene, chlorostyrene, sulfostyrene, vinyl alcohol, N-vinyl pyrrolidone, vinyl acetate, vinyl chloride, vinyl ethers, vinyl sulfides, vinyl toluene, butadiene, isoprene, chloroprene, ethylene, isobutylene, vinylidene chloride, sulfated castor oil, sulfated sperm oil, sulfated soybean oil, and sulfonated dehydrated castor oil. Particularly useful monomers include, for example, alkyl acrylates having 1-4 carbon atoms, itaconic acid, sodium sulfostyrene, and sulfated castor oil. The mixtures of the monomers, such as, for example, sodium sulfostyrene and styrene, and sulfated castor oil and acrylic acid, can be copolymerized with the methacrylic acid.

The methacrylic polymers suitable for the purposes of the present invention relates to those prepared by polymerizing methacrylic acid, with or without at least one other ethylenically unsaturated monomer described above, in the presence of sulfonated hydroxy-aromatic compound/formaldehyde condensation resins. Those homopolymers and copolymers and their preparation are described in the U.S. Pat. No. 4,940,757, the contents of which is incorporated herein by reference.

The fluoro-chemical textile anti-soilants used in the present invention are water insoluble soil repellants and have one or more fluoro-aliphatic radicals typically one or more perfluoroalkyl radicals. Preferred classes of antisoilants are the fluorocarbonyllimino biuret, the fluoroester, the fluorinated urethane compound, and the fluoropolymer.

The class of fluorocarbonylimino biurets is represented by U.S. Pat. No. 4,958,039 (Pechhold), the disclosure of which is incorporated herein by reference. As an example, mention is made of the reaction product of two moles of a mixture of fluoroalcohols of the formula F(CF₂CF₂)ₙCH₂CH₂OH, where n is predominately 5, 4, and 3, with one mole of 1,3,5-tris(6-iso-cyanotohexyl)biuret followed by reaction of residual isocyanate groups with a modifier such as 3-chloro-1,2-propanediol.

The class of fluoroesters is represented by U.S. Pat. No. 3,923,715 (Dettre) and U.S. Pat. No. 4,039,585 (Dettre), the disclosure of which is incorporated herein by reference. These patents disclose perfluoroalkyl esters of carboxylic acids of 3 to 30 carbon atoms. An example is citric acid ester of perfluoroalkyl aliphatic alcohols such as a mixture of 2-perfluoroalkyl ethanols containing 8 to 16 carbon atoms.

The class of fluoroester urethane compounds is also in aforementioned U.S. Pat. No. 4,029,585. An example is the citric acid urethane obtained by reacting the citric acid ester mentioned above with 1-methyl-2,4-diisocyanatobenzene.

The class of fluoropolymers is represented by U.S. Pat. No. 3,645,990 (Raynolds), the disclosures of which are incorporated herein by reference. The patents describe, respectively, fluorinated polymers from acrylic and methacrylic derived monomers having the structures
CH₂═CH—CO₂CH₂CH₂R_{f}
and
CH₂═C(CH₃)—CO₂CH₂CH₂R_{f}
where R_{f} is a perfluoroalkyl group of about 4 through 14 carbons, and methyl acrylate or ethyl acrylate, optionally with small amounts of other monomers. An example of such a fluoropolymer is the copolymer of the last mentioned formula, wherein R_{f} is a mixture of perfluoroaliphatic radicals of 8 to 16 carbons, with methyl methyacylate in a 74:26 weight ratio.
Analysis, Color Measurement, and Test Methods
Amine End Analysis

The amine end content of the polyamide was determined by using standard titration procedures. The procedure comprises scouring a polyamide sample with methylene chloride, drying the sample at room temperature for 30 minutes in a dessiccator, dissolving the dried sample in an 80/20 mixture of phenol/methanol (Menol) at 25° C., stirring the solution with a stir-bar for 2 hours, and titrating the solution with standardized perchloric acid 0.055N in isopropanol.

Color Measurement

Color was measured using a Varian Cary 5 spectrophotometer with 110 mm integrating sphere (Varian, Inc., Palo Alto, Calif.). This method involved collecting a baseline for 100% and 0% reflectance using PTEE reference disk, and then replacing the reference disk with the sample. Diffuse reflectance spectrum is collected. The spectral data, and xy pairs are processed using Varian Color Calculation software version 5.1.

In the table shown in the Examples, the color L is a measurement of degree of whiteness, 100 means white, 0 means black; color A is a measurement of red (+) and green (−); and color B is a measurement yellow (+) and blue (−).

Acid Dye Stain Test.

Acid dye stain resistance is evaluated using a procedure modified from the American Association of Textile Chemists and Colorists (AATCC) Method 175-2003, “Stain Resistance: Pile Floor Coverings.” 9 wt % of aqueous staining solution is prepared, according to the manufacturer's directions, by mixing cherry-flavored KOOL-AID® powder (Kraft/General Foods, White Plains, N.Y., a powdered drink mix containing, inter alia, FD&C Red No. 40). A carpet sample (4×6-inch) is placed on a flat non-absorbent surface. A hollow plastic 2-inch (5.1 cm) diameter cup is placed tightly over the carpet sample. Twenty ml of the KOOL-AID® staining solution is poured into the cup and the solution is allowed to absorb completely into the carpet sample. The cup is removed and the stained carpet sample is allowed to sit undisturbed for 24 hours. Following incubation, the stained sample is rinsed thoroughly under cold tap water, excess water is removed by centrifugation, and the sample is dried in air. The carpet sample was visually inspected and rated for staining according to the FD&C Red No. 40 Stain Scale described in AATCC Method 175-2003. Stain resistance is measured using a 1-10 scale. An undetectable test staining is accorded a value of 10. Ratings are determined by visual examination by a panel of evaluators.

Shampoo-Wash Durability Test.

A 4×6-inch nylon carpet sample is submerged for 5 minutes in a detergent solution containing 250 ml 6 wt % of sodium dodecyl sulfate (Duponol® WAQE, Witco Corporation, Greenwich, Conn.) adjusted to pH 10 with sodium phosphate. The specimen is removed from the solution, rinsed in tap water, de- and watered by centrifugation, and air-dried. The dried sample is stain tested as described above.

Repellency Test

The following liquids were used for oil repellency tests.

| Rating Number | Liquid Composition |
|---|---|
| 1 | Kaydol (Mineral Oil) |
| 2 | 65%/35% Kaydol/n-Hexadecane |
| 3 | n-Hexadecane |
| 4 | n-Tetradecane |
| 5 | n-Dodecane |
| 6 | n-Decane |

The following liquids were used for water repellency tests.

Liquid Composition

| Rating Number | % Isopropanol | % Water |
|---|---|---|
| 1 | 2 | 98 |
| 2 | 5 | 95 |
| 3 | 10 | 90 |
| 4 | 20 | 80 |
| 5 | 30 | 70 |
| 6 | 40 | 60 |

Repellency Test Procedure

In this test, five drops of number 1 liquid listed above are placed from a height of 3 mm onto the carpet surface. If after 10 seconds, four out of the five drops were still visible as spherical to hemispherical, the carpet is given a passing rating. Repeat the test with a higher number of liquids. The repellency rating of the sample is the highest number of liquid used to pass the repellency test.

Carpets with rating 4 or higher have good anti-soiling properties. Without fluoro-chemical treatment, most nylon carpets have rating of 1 for both oil and water repellency.

The invention will be described by reference to the following detailed examples. The Examples are set forth by way of illustration, and are not intended to limit the scopes of the invention.

### EXAMPLES

Bulked Continuous Fiber Spinning

Item A

The nylon polymer contained 0.3 wt % TiO₂, and 2 wt % sodium salt of 5-sulfosiophthalic acid with a relative viscosity (RV) of 68+/−3. The polymer temperature before the spinning pack was controlled at about 288+/−1° C., and the spinning throughput was 130 pounds per hour. The polymer was extruded through the spinneret and divided into four 80 filaments. The molten filaments were then rapidly quenched in a chimney, where cooling air at 10° C. was blown past the filaments at 300 cubic feet/min (0.236 cubic m/sec). The filaments were pulled by a feed roll rotating at a surface speed of 1000 yard/min (914 m/min) through the quench zone and then were coated with a lubricant for drawing and crimping. The coated yarns were drawn at 2650 yards/min (2423 m/min) (2.65×draw ratio) using a pair of heated (175° C.) draw rolls. The yarns were then forwarded into a dual-impingement bulking jet (204° C. hot air), similar to that describe in Coon, U.S. Pat. No. 3,525,134 to form four 995 denier, 12.5 denier per filament (dpf) yarns. This test yarn had 35 amine ends per million grams of copolyamide.

Item B.

This item was produced similar to item A except it was made using a nylon polymer with 18 amine ends per million grams of copolyamide, and 1.5 wt % sodium salt of 5-sulfosiophthalic acid. This item was made at 2.65×draw ratio.

Item C.

This item was produced similar to item B except at 3.6×draw ratio.

Item D.

The nylon polymer contained 0.3 wt % TiO₂, and 1 wt % sodium salt of 5-sulfosiophthalic acid with a relative viscosity (RV) of 68+/−3. The polymer temperature before the spinning pack was controlled at about 288+/−1° C., and the spinning throughput was 130 pounds per hour. The polymer was extruded through the spinneret and divided into four 80 filaments. The molten filaments were then rapidly quenched in a chimney, where cooling air at 10° C. was blown past the filaments at 300 cubic feet/min (0.236 cubic m/sec). The filaments were pulled by a feed roll rotating at a surface speed of 1000 yard/min (914 m/min) through the quench zone and then were coated with a lubricant for drawing and crimping. The coated yarns were drawn at 2650 yards/min (2423 m/min) (2.65×draw ratio) using a pair of heated (175° C.) draw rolls. The yarns were then forwarded into a dual-impingement bulking jet (204° C. hot air), similar to that describe in Coon, U.S. Pat. No. 3,525,134 to form four 995 denier, 12.5 denier per filament (dpf) yarns. This test yarn had 14 amine ends per million grams of copolyamide.

Item E

This item was produced similar to item C except it was made using a nylon polymer without TiO₂ delustrant. A steam draw assist jet was used between the feed roll and draw rolls to assist drawing. This item was made at 3.1×draw ratio. This item also had 14 amine ends per million grams of copolyamide.

Item F

This item was produced similar to item A except it was made using a nylon polymer with no sodium salt of 5-sulfosiophthalic acid. This item also had 0.3 wt % TiO₂ and 14 amine ends per million grams of copolyamide.

Item G

This item was produced similar to Item A except it was made from a nylon polymer with 0.08 wt % of TiO₂. This item had 35 amine ends per million grams of copolyamide.

Carpet Production

Items A, B, C, E, D F, and G were cable twisted 5.0×5.0 tpi on a Volkman and heatset on Superba with steam at 129.4° C. (265° F.). The heat-set yarns were tufted into a 1/10″ gauge, ⅝ inch pile height, 42 oz Saxony carpet. The carpet was dyed on a continuous Kuster dye line as described below.

### Example 1 (Comparative)

Two yards of carpet made from item G was dyed on a continuous dye line (Kuster) with acid dyes. The dye mixture included 0.031 g/l of Tectilon Orange 3G (#156), 0.015 g/l of Tectilon Red 2B (#361), 0.018 g/l of Tectilon Blue 4R (#277), and 0.50 g/l of nonionic surfactant (polyethylene oxides). The pH of the dye solution was adjusted to about 4.0. The dye solution was sprayed on the carpet with a wet pick up of about 350%. After the dyer, the carpet was processed through a steamer (saturated steam with residence time ˜3.5 minutes), and rinsed with cold water. The finished carpet had a light wheat color. Light wheat is a popular light shade color for residential carpets. Any trace of acid stains on light shade carpet is easily detected. Light wheat color is suitable for critical stain resistance tests. Latex was added to the carpet backing to secure tufts. The finished carpet was tested for stain resistances.

### Example 2

Two yards of carpet made from item B was dyed on a continuous dye line (Kuster) with acid dyes. The dye mixture included 0.02 g/l of Tectilon Yellow (#246), 0.0047 g/l of Tectilon Red 2B (#361), 0.0027 g/l of Tectilon Blue 4R (#277), and 0.50 g/l of nonionic surfactant (polyethylene oxides). The pH of the dye solution was adjusted to 4.0. The dye solution was sprayed on the carpet with a wet pick up of about 350%. After the dyer, the carpet was processed through a steamer (saturated steam with residence time ˜3.5 minutes), rinsed with cold water. The dyed carpet was treated with sulfonated phenol-formaldehyde condensation product in a flex nip tank. The solution pH was adjusted to 4.0. The wet pick was about 320%, and the amount of sulfonated phenol-formaldehyde condensation product on yarn was about 1%. The carpet was then treated with saturated steam with residence time ˜1.5 minute, rinsed with cold water and dried with hot air. The finished carpet had a wool beige color. Wool beige color is also polular light shade color for residential carpets and is useful for critical staining tests. Latex was added to the carpet backing to secure tufts. The finished carpet was tested for stain resistances.

### Example 3

Two yards of carpet made from item C was dyed on a continuous dye line (Kuster) with acid dyes. The dye mixture included 0.020 μl of Tectilon Yellow (#246), 0.0047 g/l of Tectilon Red 2B (#361), 0.0027 g/l of Tectilon Blue 4R (#277), and 0.50 μl of nonionic surfactant (polyethylene oxides). The pH of the dye solution was adjusted to 4.0. The dye solution was sprayed on the carpet with a wet pick up of about 350%. After the dyer, the carpet was processed through a steamer (saturated steam with residence time ˜3.5 minutes), rinsed with cold water. The dyed carpet was treated with sulfonated phenol-formaldehyde condensation product in a flex nip tank. The solution pH was adjusted to 4.0. The wet pick was about 320%, and the amount of sulfonated phenol-formaldehyde condensation product on yarn was about 1%. The carpet was then treated with saturated steam with residence time ˜1.5 minute, rinsed with cold water and dried with hot air. The finished carpet had a wool beige color. Latex was added to the carpet backing to secure tufts. The finished carpet was tested for stain resistances.

### Example 4

Two yards of carpet made from item A was dyed on a continuous dye line (Kuster) with acid dyes. The dye mixture included 0.020 g/l of Tectilon Yellow (#246), 0.0047 g/l of Tectilon Red 2B (#361), 0.0027 g/l of Tectilon Blue 4R (#277), and 0.50 g/l of nonionic surfactant (polyethylene oxides). The pH of the dye solution was adjusted to 4.0. The dye solution was sprayed on the carpet with a wet pick up of about 350%. After the dyer, the carpet was processed through a steamer (saturated steam with residence time ˜3.5 minutes), rinsed with cold water. The dyed carpet was treated with sulfonated phenol-formaldehyde condensation product in a flex nip tank. The solution pH was adjusted to 4.0. The wet pick was about 320%, and the amount of sulfonated phenol-formaldehyde condensation product on yarn was about 1%. The carpet was then treated with saturated steam with residence time ˜1.5 minute, rinsed with cold water and dried with hot air. The finished carpet had a wool beige color. Latex was added to the carpet backing to secure tufts. The finished carpet was tested for stain resistances.

### Example 5 (Comparative)

Two yards of carpet made from item F was dyed on a continuous dye line (Kuster) with acid dyes. The dye mixtures were 0.031 g/l of Tectilon Yellow 3R, 0.020 g/l of Tectilon Red 2B (#361), 0.0047 g/l of Tectilon Blue 4R (#277), and 0.5 g/l of nonionic wetting agent (Amwet FX). The pH of the dye solution was adjusted to about 4.0. The dye solution was sprayed on carpet with a wet pick up of about 350%. After the dyer, the carpet was processed through a steamer (saturated steam with residence time ˜3.5 minutes), and rinsed with cold water. The dyed carpet was treated with sulfonated phenol-formaldehyde condensation product in a flex nip tank. The solution pH was adjusted to about 4.0. The wet pick was about 320% and the amount of sulfonated phenol-formaldehyde condensation product on yarn was 1.0%. The carpet was then treated with saturated steam with residence time ˜1.5 minute, rinsed with cold water and dried with hot air. The finished carpet had a wool beige color. Latex was added to the carpet backing to secure tufts. The finished carpet was tested for stain resistances.

### Example 6

Two yards of carpet made from item D was dyed on a continuous dye line (Kuster) with acid dyes. The dye mixtures were 0.020 g/l of Tectilon Yellow (#246), 0.0047 g/l of Tectilon Red 2B (#361), 0.0027 g/l of Tectilon Blue 4R (#277), and 0.50 g/l of nonionic wetting agent (polyethylene oxides). The pH of the dye solution was adjusted to about 4.0. The dye solution was sprayed on carpet with a wet pick up of about 350%. After the dyer, the carpet was processed through a steamer (saturated steam with residence time ˜3.5 minutes), and rinsed with cold water. The dyed carpet was treated with sulfonated phenol-formaldehyde condensation product in a flex nip tank. The solution pH was adjusted to about 4.0. The wet pick was about 320% and the amount of sulfonated phenol-formaldehyde condensation product on yarn was 1.0%. The carpet was then treated with saturated steam with residence time ˜1.5 minute, rinsed with cold water and dried with hot air. The finished carpet had a wool beige color. Latex was added to the carpet backing to secure tufts. The finished carpet was tested for stain resistances.

### Example 7

Two yards of carpet made from item E was dyed on a continuous dye line (Kuster) with acid dyes. The dye mixtures were 0.020 g/l of Tectilon Yellow 3R (#246), 0.0047 g/l of Tectilon Red 2B (#361), 0.0027 μl of Tectilon Blue 4R (#277), and 0.50 g/l of nonionic wetting agent (polyethylene oxides). The pH of the dye solution was adjusted to about 4.0. The dye solution was sprayed on the carpet with a wet pick up of about 350%. After the dyer, the carpet was processed through a steamer (saturated steam with residence time ˜3.5 minutes), and rinsed with cold water. The dyed carpet was treated with sulfonated phenol-formaldehyde condensation product in a flex nip tank. The solution pH was adjusted to about 4.0. The wet pick was about 320% and the amount of sulfonated phenol-formaldehyde condensation product on yarn was 1.0%. The carpet was then treated with saturated steam with residence time ˜1.5 minute, rinsed with cold water and dried with hot air. The finished carpet had a wool beige color. Latex was added to the carpet backing to secure tufts. The finished carpet was tested for stain resistances.

### Example 8

Two yards of carpet made from item C was dyed on a continuous dye line (Kuster) with acid dyes. The dye mixture included 0.031 g/l of Tectilon Orange 3G (#156), 0.015 g/l of Tectilon Red 2B (#361), 0.018 g/l of Tectilon Blue 4R (#277), and 0.50 g/l of nonionic surfactant (polyethylene oxides). In addition to the dyestuff, sulfonated phenol-formaldehyde condensation product was also added to the dye bath (1% weight on yarn). The pH of the dye solution was adjusted to about 2.0. The dye solution was sprayed on the carpet with a wet pick up of about 350%. After the dyer, the carpet was processed through a steamer (saturated steam with residence time ˜3.5 minutes), rinsed with cold water and dried with hot air. Latex was added to the carpet backing to secure tufts. The finished carpet had a light wheat color was tested for stain resistances.

### Example 9

Two yards of carpet made from item A was dyed on a continuous dye line (Kuster) with acid dyes. The dye mixture included 0.020 g/l of Tectilon Yellow (#246), 0.0047 g/l of Tectilon Red 2B (#361), 0.0027 g/l of Tectilon Blue 4R (#277), and 0.50 g/l of nonionic surfactant (polyethylene oxides). In addition to the dyestuff, sulfonated phenol-formaldehyde condensation product was also added to the dye bath (1% weight on yarn). The pH of the dye solution was adjusted to about 2.0. The dye solution was sprayed on the carpet with a wet pick up of about 350%. After the dyer, the carpet was processed through a steamer (saturated steam with residence time ˜3.5 minutes), rinsed with cold water and dried with hot air. Latex was added to the carpet backing to secure tufts. The finished carpet had a wool beige color was tested for stain resistances.

### Example 10

Two yards of carpet made from item D was dyed on a continuous dye line (Kuster) with acid dyes. The dye mixtures were 0.020 g/l of Tectilon Yellow 3R (#246), 0.0047 g/l of Tectilon Red 2B (#361), 0.0027 g/l of Tectilon Blue 4R (#277), and 0.50 g/l of nonionic wetting agent (polyethylene oxides). In addition to the dyestuff, sulfonated phenol-formaldehyde condensation product, and fluoroester urethane compound were also added to the dye solution. The amount of sulfonated pheno-formaldehyde condensation product was adjusted for 1% on yarn. The amount of fluoroester urethane compound was adjusted for 600 ppm on yarn. The pH of the dye solution was adjusted to about 0.95. The dye solution was sprayed on the carpet with a wet pick up of about 350%. After the dyer, the carpet was processed through a steamer (saturated steam with residence time ˜3.5 minutes), rinsed with cold water and dried with hot air. Latex was added to the carpet backing to secure tufts. The finished carpet had a wool beige color, and was tested for stain resistances and oil/water repellency.

### Example 11, 12 and 13

Two yards of carpet made from item D, E and F were dyed on a continuous dye line (Kuster) with acid dyes. The dye mixtures were 0.158 g/l of Tectilon Orange 3G (#156), 0.05 g/l of Tectilon Red 2B (#361), 0.395 g/l of Tectilon Blue 4R (# 277), and 0.50 g/l of nonionic wetting agent (polyethylene oxides). The pH of the dye solution was adjusted to about 4.0. The dye solution was sprayed on the carpets with a wet pick up of about 350%. After the dyer, the carpets were processed through a steamer (saturated steam with residence time ˜3.5 minutes), and rinsed with cold water. The dyed carpets were treated with sulfonated phenol-formaldehyde condensation product in a flex nip tank. The solution pH was adjusted to about 4.0. The wet pick was about 320% and the amount of sulfonated phenol-formaldehyde condensation product on yarn was 1.0%. The carpets were then treated with saturated steam with residence time ˜1.5 minute, rinsed with cold water and dried with hot air. The finished carpet had a dark forest green color. Forest green is a dark shade color for residential carpets. Acid grains on dark shade carpet is easily detected. Latex was added to the carpet backing to secure tufts. The stain test results of the finished carpets are shown in Table 1.

### Example 14, 15 and 16

Two yards of carpet made from item D, E and F were dyed on a continuous dye line (Kuster) with acid dyes. The dye mixtures were 0.158 g/l of Tectilon Orange 3G (#156), 0.05 g/l of Tectilon Red 2B (#361), 0.395 g/l of Tectilon Blue 4R (# 277) and 0.50 g/l of nonionic wetting agent (polyethylene oxides). The pH of the dye solution was adjusted to about 4.0. The dye solution was sprayed on the carpet with a wet pick up of about 350%. After the dyer, the carpets were processed through a steamer (saturated steam with residence time ˜3.5 minutes), and rinsed with cold water. No post dyeing chemical was applied to the carpets. The finished carpets had a dark forest green color. Latex was added to the carpet backing to secure tufts. The stain test results of the finished carpets are shown in Table 1

TABLE 1
Stain Resist Test Results

| Example | Item | Color L | Color A | Color B | 24 hrs | 1WAQE | 2WAQE | 3WAQE | 4WAQE | 5WAQE | W/O | Comments |
|---|---|---|---|---|---|---|---|---|---|---|---|---|
| 1 | G | 67.97 | 5.32 | 21.32 | 2 | 2 | | | | | 1/1 | Fail |
| 2 | B | 84.29 | 3.19 | 16.47 | 10 | 10 | 10 | 9 | 9 | 8 | 1/1 | Pass |
| 3 | C | 85.34 | 3.10 | 16.86 | 10 | 10 | 10 | 9 | 9 | 9 | | Pass |
| 4 | A | 84.36 | 2.69 | 16.49 | 9 | 9 | 8 | 7 | 5 | 4 | | Fail |
| 5 | F | 82.39 | 1.07 | 15.16 | 10 | 9 | 9 | 8 | 7 | 5 | | Fail |
| 6 | D | 85.58 | 2.27 | 15.40 | 10 | 10 | 10 | 9 | 9 | 8 | | Pass |
| 7 | E | 78.06 | 3.37 | 17.67 | 10 | 10 | 10 | 10 | 10 | 9 | 1/1 | Pass |
| 8 | C | 68.1 | 5.07 | 22.7 | 10 | 10 | 10 | 10 | 9 | 9 | | Pass |
| 9 | A | 67.1 | 4.88 | 21.5 | 10 | 9 | 9 | 8 | 6 | 3 | | Fail |
| 10 | D | — | — | — | 9 | 8 | 8 | 8 | 8 | 8 | 6/5 | Pass |
| 11 | D | 38.01 | −6.64 | 4.45 | 10 | 10 | 10 | 10 | 10 | 10 | | Pass |
| 12 | E | 31.09 | −5.33 | 5.08 | 10 | 10 | 10 | 10 | 10 | 10 | | Pass |
| 13 | F | 27.98 | −5.63 | 1.69 | 10 | 10 | 10 | 10 | 10 | 10 | | Pass |
| 14 | D | 32.34 | −5.92 | 2.56 | 4 | | | | | | | Fail |
| 15 | E | 27.98 | −4.41 | 4.08 | 4 | | | | | | | Fail |
| 16 | F | 29.38 | −5.36 | 2.34 | 4 | | | | | | | Fail |

Note:
W/O water and oil repellency

What is claimed is:

1. A process for making permanent acid stain resistant polyamide carpet comprising:
(a) melting a cationic dyeable polyamide copolymer with low amine ends;
(b) spinning the copolymer melt into a yarn;
(c) heating set the yarn on superba with steam;
(d) tufting the heat-set yarn into a carpet;
(e) spraying acid dyes on the carpet;
(f) steaming, and rinsing the carpet;
(g) adding stain resist compositions on the carpet after rinsing; and
(h) steaming, rinsing, and drying the carpet.

2. The process of claim 1, wherein the amine ends is about 12 to about 18 per million gram of polyamide yarn.

3. The process of claim 1, wherein the heat-set is performed at temperatures of 110 to 140° C.

4. The process of claim 1, wherein step (e) is performed at a ph of about 3 to about 5.

5. The process of claim 1, wherein the carpet so produced has a color 1 value at least 60.

6. The process of claim 1, wherein the carpet so produced has a color 1 value at least 70.

7. The process of claim 1, wherein step (g) is performed at a ph of about 1.5 to about 5.0.

8. The process of claim 1, wherein the stain resist composition is selected from the group consisting of sulfonated phenol-aldehyde condensation products, and sulfonated naphthol condensation product

9. The process of claim 1, wherein the stain resist composition is selected from the group consisting of sulfonated phenol-aldehyde condensation products, and sulfonated naphthol condensation produ, polymethacrylic acid polymers, acrylic acid polymers, copolymers of acrylic acid or methacrylic acid with ethylenically unsaturated comonomers, and hydrolyzed maleic anhydride copolymer with ethylenically unsaturated comonomers.

10. The process of claim 1, wherein a fluorochemical is added into step (g).

11. The process of claim 10, wherein step (g) is performed at a ph of about 0.8 to about 2.5.

12. The process of claim 10, wherein the fluorochemical is selected from the groups consisting of a flurocarbonyllimino biuret, a fluroester, a fluoroester carbamate, and a fluoropolymer.

13. A uniformly lightly colored carpet made from a cationic dyeable polyamide fiber with low amine ends having a built-in permanent anti-stain resistance according to the process of claim 1.

14. A process for making permanent acid stain resistant polyamide carpet comprising:
(a) melting a cationic dyeable polyamide copolymer with low amine ends;
(b) spinning the copolymer melt into a yarn;
(c) heating set the yarn on superba with steam;
(d) tufting the heat-set yarn into a carpet;
(e) spraying a mixture of acid dyes and stain resist compositions on the carpet; and
(f) steaming, rinsing, and drying the carpet.

15. The process of claim 14, wherein the amine ends is about 12 to about 18 per million gram of polyamide yarn.

16. The process of claim 14, wherein the heat-set is performed at temperatures of 110 to 140° C.

17. The process of claim 14, wherein step (e) is performed at a ph of about 1.0 to about 3.0.

18. The process of claim 14, wherein the carpet so produced has a color 1 value at least 60.

19. The process of claim 14, wherein the carpet so produced has a color 1 value at least 70.

20. The process of claim 14, wherein the stain resist composition is selected from the group consisting of sulfonated phenol-aldehyde condensation products, and sulfonated naphthol condensation product.

21. The process of claim 14, wherein the stain resist compositions is selected from the group consisting of sulfonated phenol-aldehyde condensation products, and sulfonated naphthol condensation product. Polymethacrylic acid polymers, acrylic acid polymers, copolymers of acrylic acid or methacrylic acid with ethylenically unsaturated comonomers, and hydrolyzed maleic anhydride copolymer with ethylenically unsaturated comonomers.

22. The process of claim 14, wherein a flurochemical is added into step (e).

23. The process of claim 22, wherein step (e) is performed at a ph of about 0.8 to about 2.5.

24. The process of claim 22, wherein the fluorochemical is selected from the groups consisting of a flurocarbonyllimino biuret, a fluroester, a fluoroester carbamate, and a fluoropolymer.

25. A uniformly lightly colored carpet made from a cationic dyeable polyamide fiber with low amine ends having a built-in permanent anti-stain resistance according to the process of claim 14.
